(19) United States
(12) Patent Application Publication
(10) Pub. No.: US 2006/0089811 A1
(43) Pub. Date: Apr. 27, 2006

(54) Method of detecting contamination and method of determining detection threshold in genotyping experiment

(76) Inventors: Kyusang Lee, Suwon-si (KR); Kyung-hee Park, Seoul (KR); Kyoung-a Kim, Gwangmyeong-si (KR); Ok-ryul Song, Seoul (KR)

Correspondence Address: CANTOR COLBURN, LLP, 55 GRIFFIN ROAD SOUTH, BLOOMFIELD, CT, 06002, US

(21) Appl. No.: 11/128,736

(22) Filed: May 13, 2005

(30) Foreign Application Priority Data
Oct. 22, 2004 (KR) 10-2004-0084873

(51) Int. Cl. G06F 19/00

(52) U.S. Cl. 702/20

(57) ABSTRACT

A method of detecting a contamination event by using a blank well and a replicate well occurring during a high-throughput screening is provided. In the method, a logistic regression equation for detecting a contamination in a genotyping experiment is determined, and a BWE (blank well error), an IRF (intraplate replicate failure) and an HWE (Hardy-Weinberg equilibrium) occurring in a blank well and a replicate well of a well plate during the genotyping experiment are checked. The contamination is detected based on a result value of the logistic regression equation, which is calculated by using the BWE, the IRF and the HWE as input variables of the logistic regression equation. Thus, the contamination can be precisely measured by the quantitative indexes without any qualitative analysis.

### BACKGROUND OF THE INVENTION

This application claims the priority of Korean Patent Application No. 10-2004-0084873, filed on Oct. 22, 2004, in the Korean Intellectual Property Office, the disclosure of which is incorporated herein in its entirety by reference.

1. Field of the Invention

The present invention relates to a method of detecting a contamination in a genotyping experiment, and more particularly, to a method of detecting a contamination by using a blank well and a replicate well of a well plate.

2. Description of the Related Art

In a conventional high-throughput genotyping experiment that uses a 96/384 plate, a blank well or a replicate well is used to detect contamination events.

In the method of detecting the contamination by using the blank well, a contamination detection standard (negative control) of the well due to an external gDNA is inaccurate and several contaminated blank wells (negative control well) are insufficient to represent a contamination of the entire well plates through about 300 tests.

When a contamination of a plate is detected by using a replicate well containing the same gDNA of the test object, a standard of a contamination detection varies depending on user's conditions. Also, for the detection of contamination, an analysis based on sufficient amount of test data is demanded. In addition, an indirect help can be obtained through a quantitative analysis using a scatter plot, which represents signal strength of two alleles.

### SUMMARY OF THE INVENTION

The present invention provides a method of detecting a contamination and a method of determining a detection threshold in a genotyping experiment, in which a contamination can be accurately detected using a blank well and a replicate well of a well plate and also a contamination can be automatically detected using quantitative indices without qualitative analysis.

Also, the present invention provides a computer-readable recording medium storing a program of executing a method of detecting a contamination event and a method of determining a detection threshold in a genotyping experiment, in which a contamination event can be accurately detected using a blank well and a replicate well in a well plate and also a contamination can be automatically detected using quantitative indices without a qualitative analysis.

According to an aspect of the present invention, there is provided a method of determining a detection threshold of contamination in a genotyping experiment using a blank well and a replicate well of a well plate. The method includes: checking a BWE (blank well error), an IRF (intraplate replicate failure) and an HWE (Hardy-Weinberg equilibrium); checking whether a distribution in the genotyping experiment result of the well plate is a contaminated state or a normal state; executing a logistic regression having the BWE, and the IRF and the HWE as variables; and determining values of the respective variables of the logistic regression by using an ROC (receiver operating characteristics) analysis.

According to another aspect of the present invention, there is provided a method of detecting a contamination including: determining a logistic regression equation for detecting a contamination in a genotyping experiment; checking a BWE (blank well error), an IRF (intraplate replicate failure) and an HWE (Hardy-Weinberg equilibrium) occurring in a blank well and a replicate well of a well plate during the genotyping experiment; and detecting the contamination based on a result value of the logistic regression equation, which is calculated by using the BWE, the IRF and the HWE as input variables of the logistic regression equation.

### BRIEF DESCRIPTION OF THE DRAWINGS

The above and other features and advantages of the present invention will become more apparent by describing in detail exemplary embodiments thereof with reference to the attached drawings in which:

FIG. 1 is a view of a well plate for detecting a contamination by using a blank well;

FIG. 2 is a view of a well plate for detecting a contamination by using a replicate well;

FIGS. 3A through 3C are scatter plots showing result of a genotyping experiment;

FIG. 4 is an ROC curve for selection of coefficient;

FIG. 5 is a view of an ROC analysis result of FIG. 4; and

FIG. 6 is a flowchart showing a method of detecting a contamination in a genotyping experiment by using a logistic regression.

### DETAILED DESCRIPTION OF THE INVENTION

A method for quantifying an initial concentration of a nucleic acid from a real-time nucleic acid amplification data, especially, a PCR data will now be described with reference to the accompanying drawings.

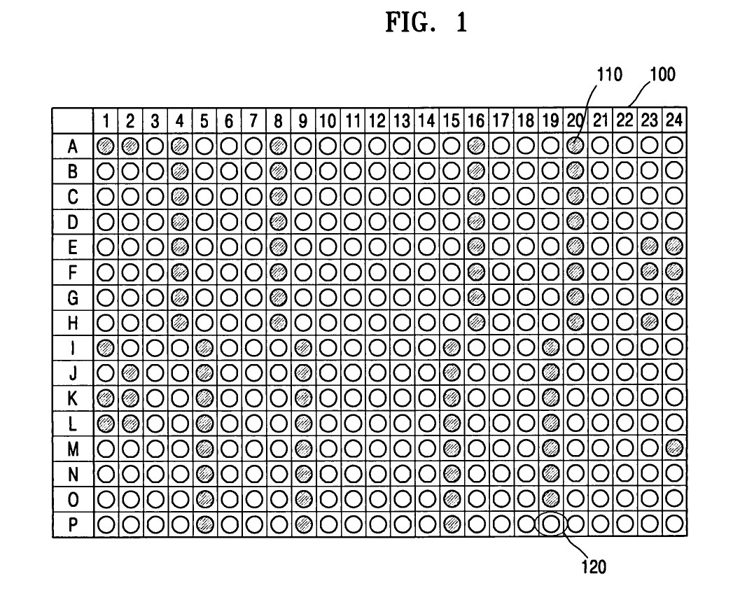

FIG. 1 is a view of a well plate for detecting a contamination by using a blank well.

Referring to FIG. 1, a well plate 100 for a genotyping experiment includes blank wells 110 disposed spaced apart by a predetermined distance. The blank well 110 has about 10% (40 wells) of 384 plate and other reagents required in a reaction are injected into the blank well without a gDNA. When the gDNA is contaminated, an unexpected signal of genotype is detected from the blank well 120. This is because the blank well contains all the ingredients needed for genotyping reaction except the template DNA, and the unexpected signal is due to the contaminant gDNA introduced by contamination. An overall contamination can be monitored by uniformly distributing positions of about 40 wells on the 384 well plate. Accordingly, a contamination occurring in the blank well of the well plate, that is, a blank well error (BWE) (%), can be checked.

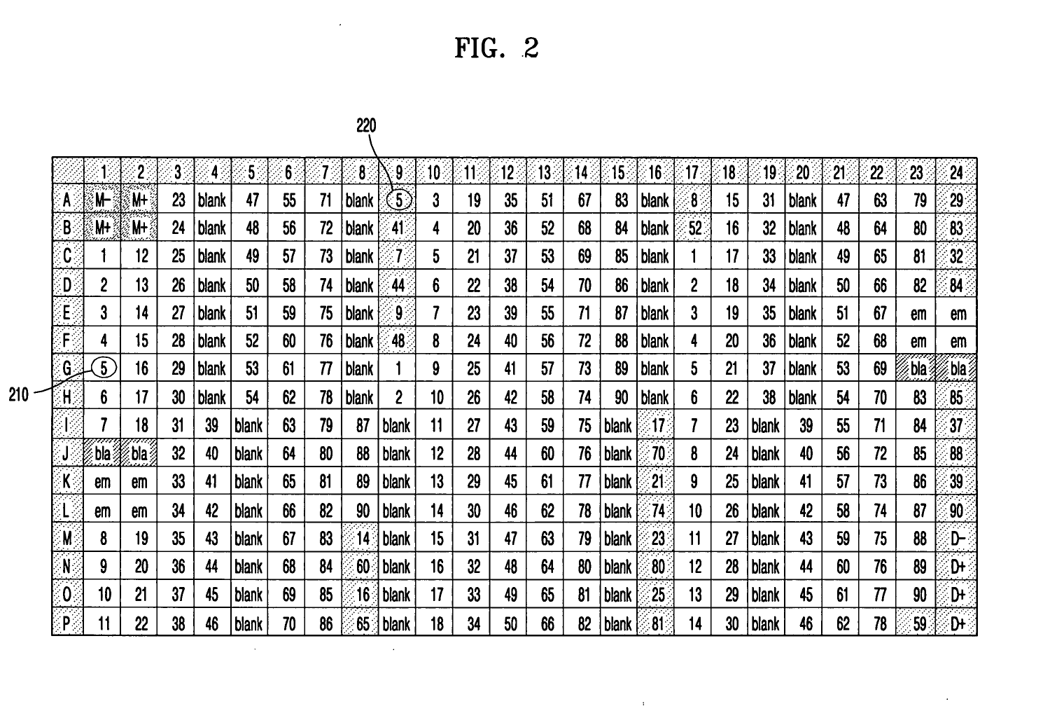

FIG. 2 is a view of the well plate for detecting a contamination by using a replicate well.

Referring to FIG. 2, randomly selected 40 gDNA samples of the test objects that are being processed together in the same 384 well plate are re-injected into 40 other wells on the same plate which are called intra-plate replicate wells. Genotype experiment is carried out with the duplicating gDNA samples and blank wells at the same time. The genotype of the replicate well 220 is different from that of the original well 210, when the replicate well (a replicate well 220 of a fifth well 210) is contaminated by other gDNA. Accordingly, an intraplate replicate failure (%) can be checked.

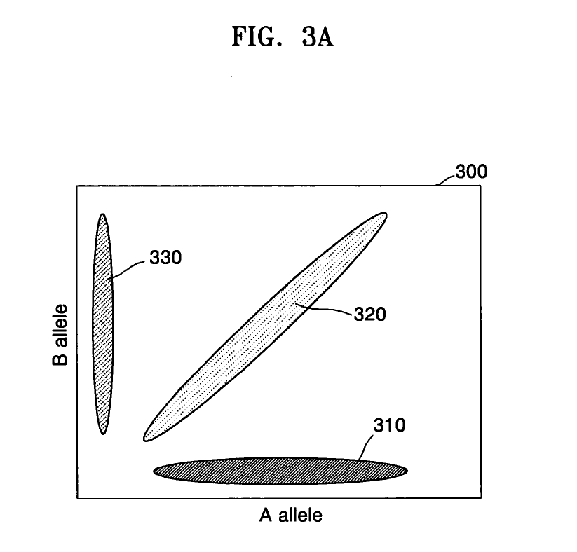

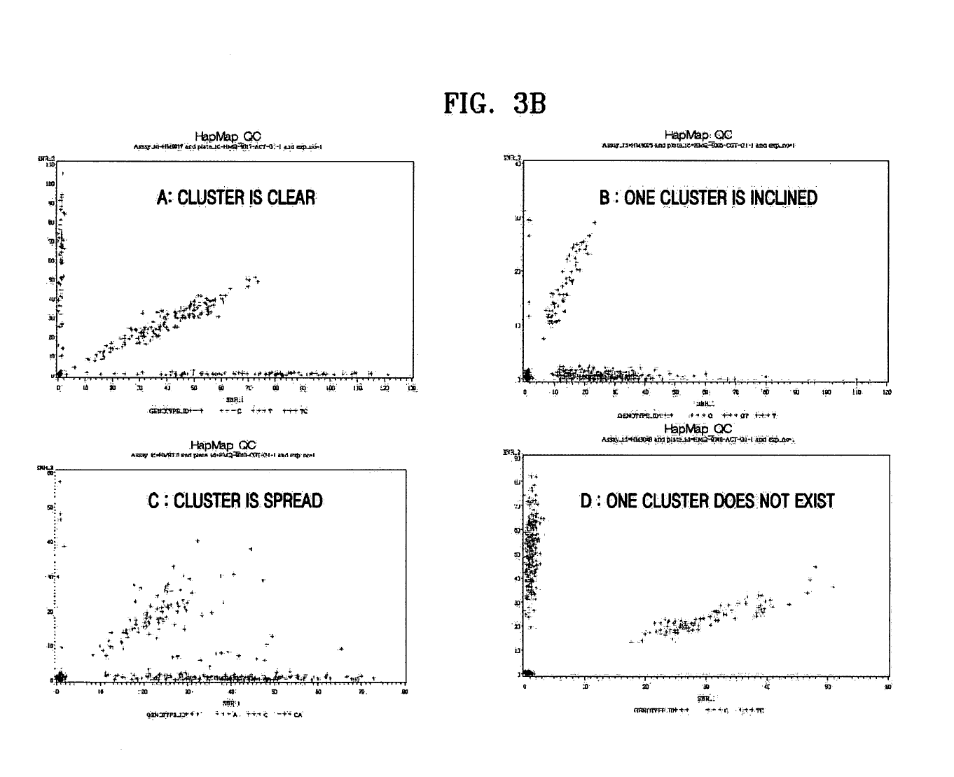

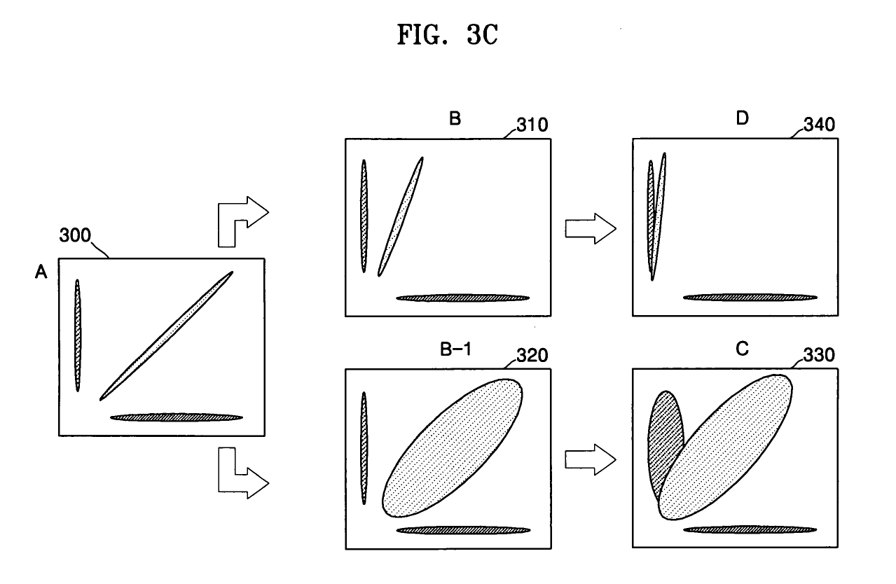

FIGS. 3A through 3C are scatter plots showing result of the genotyping experiment.

Referring to FIG. 3A, x and y axes of the scatter plot denote signal strength of alleles representing the genotype. In FIG. 3A, there are shown clusters occurring when a distribution of ideal genotypes having no contamination is displayed on the scatter plot. The clusters 310 and 330 disposed parallel with the respective axes are homozygous clusters whose genotypes are AA 310 and BB 330, respectively. Meanwhile, the cluster 320 disposed in a diagonal direction is a heterozygous cluster whose genotype is AB.

Referring to FIG. 3B, a genotype screening result of a real plate is shown on the scatter plot. In type A where there is no contamination, a distribution of the genotyping experiment result is shown like the clusters of FIG. 3A. However, the plate is contaminated by various causes. The clusters are skew in one direction (type B), or widely distributed (type C), or overlapped (type D), depending on the degree of the contamination. These types of the clusters depending on the contamination are shown in FIG. 3C.

Referring to FIG. 3C, the clusters are skewed in one direction (types B and D) or overlapped with each other (type C), depending on the contamination occurring in the genotyping experiment. If the contamination occurs above a predetermined level (the case where the clusters are overlapped), the genotype screening result cannot be used.

A method of detecting the contamination in the genotyping experiment result through an automatic process will now be described.

First, in order to set a detection threshold of a contamination, the genotyping experiment is performed on a predetermined plate by using the blank well and the replicate well, such that genotypes of the wells are checked. A BWE is checked using the blank well and an IRF is checked by comparing the genotype results of the corresponding replicate well which should generate the same result. Then, it is checked whether the final genotyping experiment result satisfies Hardy-Weinberg equilibrium (HWE:1 or 0). If it satisfies the Hardy-Weinberg equilibrium, there is much less possibility of contamination.

In practice, one decides the prototypical classes of the cluster plots that belong to unusable contamination level are decided in advance with test runs. The test run genotyping experiments are checked whether the cluster distribution in the cluster plots and BWE and IRF in order to decide where each genotyping experiment from different plates belong to usable class or not. The level of acceptance for usable class is different among application of the results. This can be decided using Monte Carlo simulation or extensive review of test runs and resultant analyses.

When the contamination is identified, the BWE, the IRF and the Hardy-Weinberg equilibrium (HWE) obtained from the genotyping experiment result of the well plate substitute for variables of a logistic regression equation below.
y=β₀+x₁β₁+x₂β₂+x₃β₃
where x₁=BWE, x₂=IRF, x₃=HWE and β₀, β₁, β₂, β₃ are coefficients.

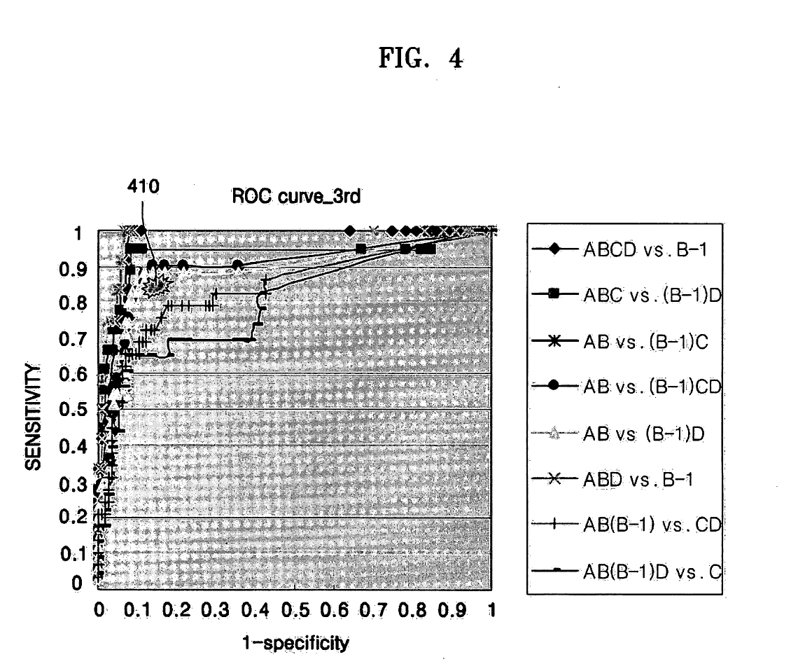

Preferable values of the coefficients β₀, β₁, β₂, β₃ calculated based on the test example shown in FIG. 4 are −2.1312, 6.3798, 1.2803 and 0.9424, respectively. The logistic regression is used as one discrete distinguishing method using predetermined data. A neural network, a decision tree, a support vector machines or the like can also be used for the same purpose. In addition, after the experimental results are classified into (A, B, B-1) vs (C, D) by using the logistic regression, they are again classified into C and D by using the logistic regression.

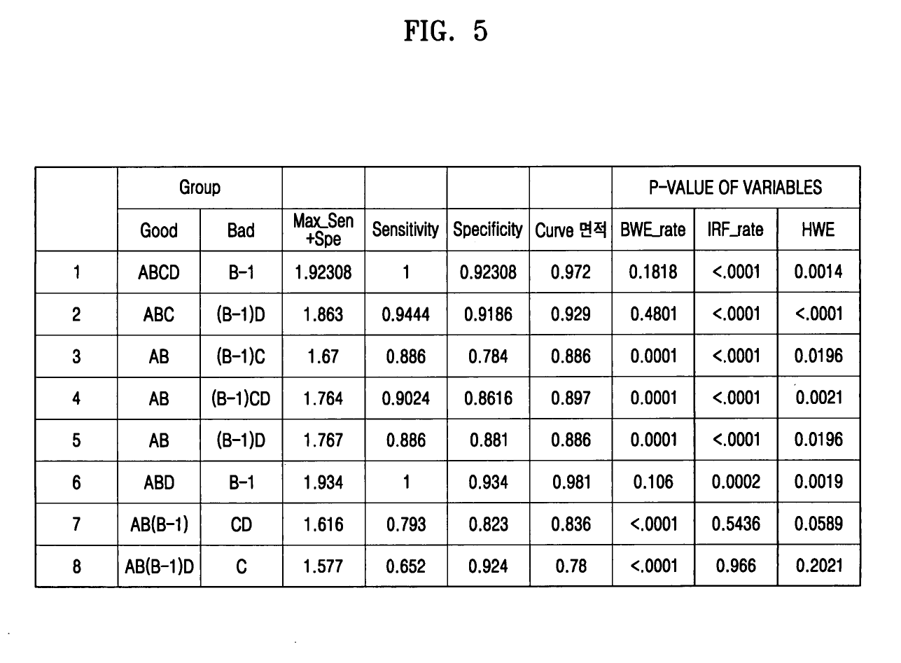

FIG. 4 is a receiver operating characteristics (ROC) curve for selection of the coefficients, and FIG. 5 is a view of an ROC analysis result shown in FIG. 4.

In FIG. 4, the ROC curve ((A, B, B-1) vs (C, D)) with respect to the types A 300, B 310, B-1 320, C 330 and D 340 is shown. In more detail, the ROC curves with respect to ABCD vs B-1, ABC vs (B-1)D, AB vs (B-1)C, AB vs (B-1)CD, ABD vs (B-1)D, AB(B-1) vs CD, and AB(B-1)D vs C are shown. In the analysis result (FIG. 5) for the curve, point 410 having the highest sensitivity and specificity is found. The point 410 serves as the reference in the classification of the types shown in FIG. 3C.

For example, in case where it is intended to find the groups C and D defined as the contaminated groups through the curve and the ROC analysis result shown in FIGS. 4 and 5, the optimum point 410 (a seventh group in FIG. 5) having the sensitivity of 79.3% and the specificity of 82.3% is obtained as the result of AB(B-1) vs CD. Then, from the analysis result of the point, the values of the respective coefficients of the logistic regression equation above are set.

Now that the logistic model has been set up, the contamination can be checked by substituting the values of the BWE, the IRF and the HWE obtained from the genotyping experiment of the well plate in the logistic regression equation without resorting to visual inspection of cluster plot.

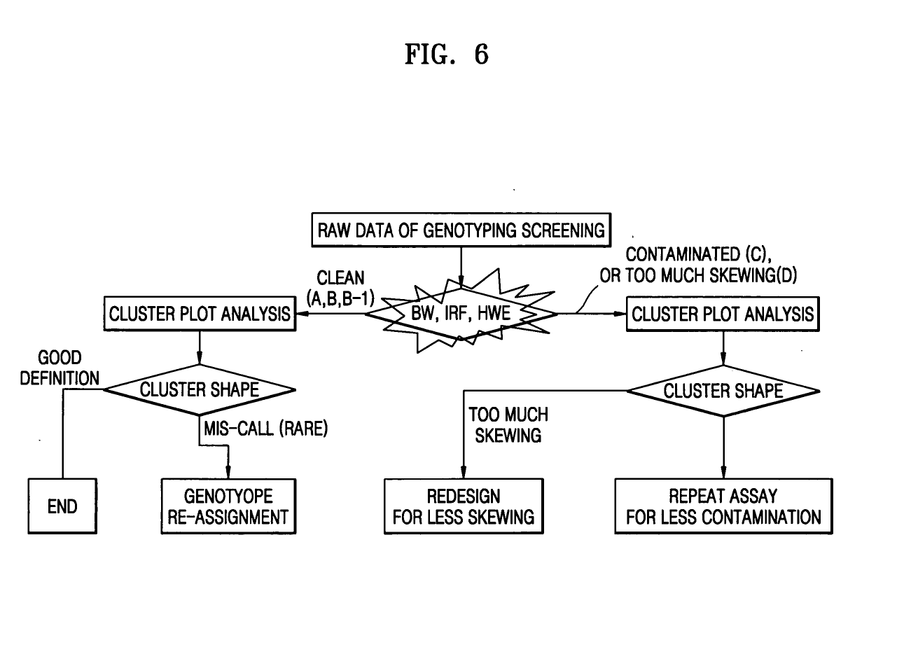

FIG. 6 is a flowchart showing a method of detecting the contamination in the genotyping experiment by using the logistic regression.

If the contamination occurs in the genotyping experiment, a predetermined class among those in FIG. 3C is classified into the contaminated one and the results cannot be used. A reference point is determined so as to distinguish the contaminated type from the normal type by using the curve and the ROC analysis result of FIGS. 4 and 5. Then, the coefficients of the logistic regression equation are set. Accordingly, the types of FIG. 3C can be classified according to the result values of the logistic regression.

After the coefficients of the logistic regression equation are set, the values of the BWE, the IRF and the HWE are substituted into the logistic regression equation and the contamination can be detected by the result.

According to the present invention, in the high-throughput genotyping experiment, the contamination can be precisely measured by the quantitative indexes such as BWE, IRF and HWE without any qualitative analysis.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of determining a detection threshold of contamination in a genotyping experiment using a blank well and a replicate well of a well plate, the method comprising:
checking a BWE (blank well error), an IRF (intraplate replicate failure) and an HWE (Hardy-Weinberg equilibrium);
checking whether a distribution in the genotyping experiment result of the well plate is a contaminated state or a normal state;
executing a logistic regression having the BWE, and the IRF and the HWE as variables; and
determining coefficients of the respective variables of the logistic regression by using an ROC (receiver operating characteristics) analysis.

2. The method of claim 1, further comprising:
completing a logistic regression equation by using the coefficients; and
checking an occurrence of contamination by inputting a BWE, a IRF and a HWE of a test well plate into the logistic regression equation, the BWE, the IRF and the HWE of the test well plate being quantitative values obtained in a genotyping experiment.

3. The method of claim 1, wherein the checking of the distribution comprises:
displaying the genotyping experiment result of the well plate through a scatter plot having x and y axes representing alleles;
classifying distribution of genotypes displayed on the scatter plot into a contaminated state and a normal state; and
determining whether the distribution of the genotyping experiment result is the contaminated state or the normal state.

4. The method of claim 1, wherein the determining of the values of the respective variables comprises:
setting a point having high specificity and sensitivity in an ROC curve as a threshold point that classifies the contaminated state and the normal state; and
determining the coefficients of the logistic regression equation based on the threshold point.

5. A method of detecting a contamination, comprising:
determining a logistic regression equation for detecting a contamination in a genotyping experiment;
checking a BWE (blank well error), an IRF (intraplate replicate failure) and an HWE (Hardy-Weinberg equilibrium) occurring in a blank well and a replicate well of a well plate during the genotyping experiment; and
detecting the contamination based on a result value of the logistic regression equation, which is calculated by using the BWE, the IRF and the HWE as input variables of the logistic regression equation.

6. The method of claim 5, wherein the determining of the logistic regression equation comprises:
classifying distribution of genotypes into a contaminated state and a normal state;
finding a threshold point that classifies the contaminated state and the normal state through an ROC (receiver operating characteristics) analysis; and
determining the logistic regression equation based on the threshold point.

7. A computer-readable recording medium storing a program of executing the method of claim 5.
